(19) United States
(12) Patent Application Publication
(10) Pub. No.: US 2014/0125880 A1
(43) Pub. Date: May 8, 2014

(54) TOUCH DEVICE, TOUCH DISPLAY THEREOF, AND ELECTRONIC APPARATUS THEREOF

(71) Applicant: INNOLUX CORPORATION, MIAO-LI COUNTY (TW)

(72) Inventors: YU-CHENG TSAI, Changhua County (TW); Chao- Liang Lu, Miaoli County (TW)

(73) Assignee: INNOLUX CORPORATION, MIAO-LI COUNTY (TW)

(21) Appl. No.: 14/058,866

(22) Filed: Oct. 21, 2013

(30) Foreign Application Priority Data
Nov. 7, 2012 (TW) 101141302

(51) Int. Cl. G02F 1/1333; G02F 1/1368

(52) U.S. Cl. CPC G02F 1/13338; G02F 1/1368
USPC 349/12

(57) ABSTRACT

A touch device comprises a substrate, multiple floating gate transistors, multiple first touch electrode lines, and multiple second touch electrode lines. The floating gate transistors are formed on the substrate. Each of the floating gate transistors includes a first electrode, a second electrode, and an active layer located between the first electrode and the second electrode. The first touch electrode lines extending along with a row direction are parallel to each other, and the second touch electrode lines extending along with a column direction are parallel to each other. The first electrodes of the floating gate transistors arranged on the same row are electrically connected to the same first touch electrode line, and the second electrodes of the floating gate transistors arranged on the same column are electrically connected to the same second touch electrode line.

### BACKGROUND

1. Technical Field

The present disclosure relates to a touch display, in particular, to a touch display having multiple floating gate transistors and an electronic apparatus thereof.

2. Description of Related Art

Conventional touch displays are almost out-cell touch displays. The out-cell touch display is formed by a touch control panel and a liquid crystal display panel, thus having at least three glass layers. Therefore, the out-cell touch display is heavy and thick, and does not meet the trend which the electronic product should be thin, short, light, and small.

Additionally, someone nowadays proposes a structure of an in-cell touch display which a touch sensor layer is directly embedded in a liquid crystal display panel. When a finger or a touch tool touches the conventional in-cell touch display, the conventional in-cell touch display determines a touch position according to a capacitance difference between the capacitances before and after the conventional in-cell touch display is touched, wherein the capacitance is formed by the touch control sensing line and the touch control sensing line. However, since the conventional in-cell touch display needs a touch control layer manufactured in a liquid crystal display panel, additional process and cost are required. Furthermore, the extra manufactured touch control sensing layer is prone to generate parasitic capacitance with other electrodes and to effect liquid crystal deflection, therefore resulting problems of the decreased sensing precision and uneven display lightness.

### SUMMARY

An exemplary embodiment of the present disclosure provides a touch device comprising a substrate, a plurality of floating gate transistors, plurality of first touch electrode lines, and a plurality of second touch electrode lines. The floating gate transistors are formed on the substrate, wherein each of the floating gate transistors comprises a first electrode, a second electrode, and an active layer located between the first electrode and the second electrode. The first touch electrode lines are extending along with a row direction and arranged parallel to each other and. The second touch electrode lines are extending along with a column direction and arranged parallel to each other. The first electrodes of the floating gate transistors arranged on a same row are electrically connected to the same first touch electrode line, and the second electrodes of the floating gate transistors arranged on a same column are electrically connected to the same second touch electrode line.

An exemplary embodiment of the present disclosure provides a touch display comprising a first substrate and a plurality of pixel units. The pixel units are formed on the first substrate, wherein at least the pixel unit comprises a gate line, a data line, a thin-film transistor (TFT), and a floating gate transistor. The gate line is extending along with a row direction. The data line is extending along with a column direction. The TFT is electrically connected to the gate line and the data line. The floating gate transistor comprises a first electrode, and an active layer located between the first electrode and the second electrode. When a charged object approaches to the floating gate transistor, the first electrode, the second electrode, and the active layer form a channel.

An exemplary embodiment of the present disclosure provides an electronic apparatus comprising an electronic apparatus body and the mentioned touch display, wherein the touch display is electrically connected to the electronic apparatus body.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A is a planar view diagram of a touch device according to an exemplary embodiment of the present disclosure.

FIG. 1B is a planar view diagram of a touch device according to another exemplary embodiment of the present disclosure.

FIG. 2 is a section view diagram of a touch display according to an exemplary embodiment of the present disclosure.

FIG. 3 is a planar view diagram of a touch display according to an exemplary embodiment of the present disclosure.

FIG. 4 is a planar view diagram of a touch display according to another exemplary embodiment of the present disclosure.

FIG. 5 is a planar view diagram of a touch display according to another exemplary embodiment of the present disclosure.

FIG. 6 is a planar view diagram of a touch display according to another exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

An exemplary embodiment of the present disclosure provides a touch device having a plurality of floating gate transistors formed on its substrate (such as an insulation substrate), wherein the floating gate transistors are arranged in an array. The floating gate transistor may not need to have a gate, and an active layer of the floating gate transistor is coupled to the substrate directly or indirectly (such as through a black matrix layer); or alternatively, the floating gate transistor may have a gate, but the gate is floating. A first electrode (such as a drain) and a second electrode (such as a source) of the floating gate transistor are used to receive a touch control driving signal and transmit a touch control sensing signal respectively.

When a charged object, such as a finger or the other touch tool approaches to the substrate, the finger with static electricity or the other touch tool makes the corresponding floating gate transistor turned on, and thus the touch control driving signal received by the drain of the floating gate transistor can pass through the floating gate transistor to form the touch control sensing signal at the source of the floating gate transistor.

An exemplary embodiment of the present disclosure further provides a touch display, wherein the touch display can be an out-cell touch display with the mentioned, but the present disclosure is not limited thereto. Another exemplary embodiment of the present disclosure further provides a touch display, wherein the touch display can be an in-cell touch display with a plurality of floating gate transistors, and each of the floating gate transistors is arranged corresponding to one or multiple TFTs. In addition, an exemplary embodiment of the present disclosure further provides an electronic apparatus having the mentioned touch device or the mentioned touch display.

An in-cell touch display in the exemplary embodiment of the present disclosure comprises a first substrate and a plurality of pixel units. The pixel units are formed on the first substrate (such as a transparent insulation substrate) and arranged in an array, wherein at least one of the pixel units comprises a gate line, a data line, a TFT, and a floating gate transistor. The gate line is extending along with a row direction, and the data line is extending along with a column direction. The TFT is electrically connected to the gate line and the data line, and the floating gate transistor comprises a first electrode, a second electrode, and an active layer. The active layer is located between the first electrode and the second electrode. When the charged object approaches to the floating gate transistor, the first electrode, the second electrode, and the active layer form a channel.

The in-cell touch display further comprises a liquid crystal layer, a second substrate (such as a transparent insulation substrate), and a back-light source. The liquid crystal layer is located o the pixel units, the second substrate is located on liquid crystal layer, and the back-light source is located on the second substrate. Thus, it is known that the in-cell touch display must be put upside down when using, i.e. the first substrate must face the user, and the second substrate is used to receive the back-light source, such as the white back-light source, or the red, green, and blue back-light source.

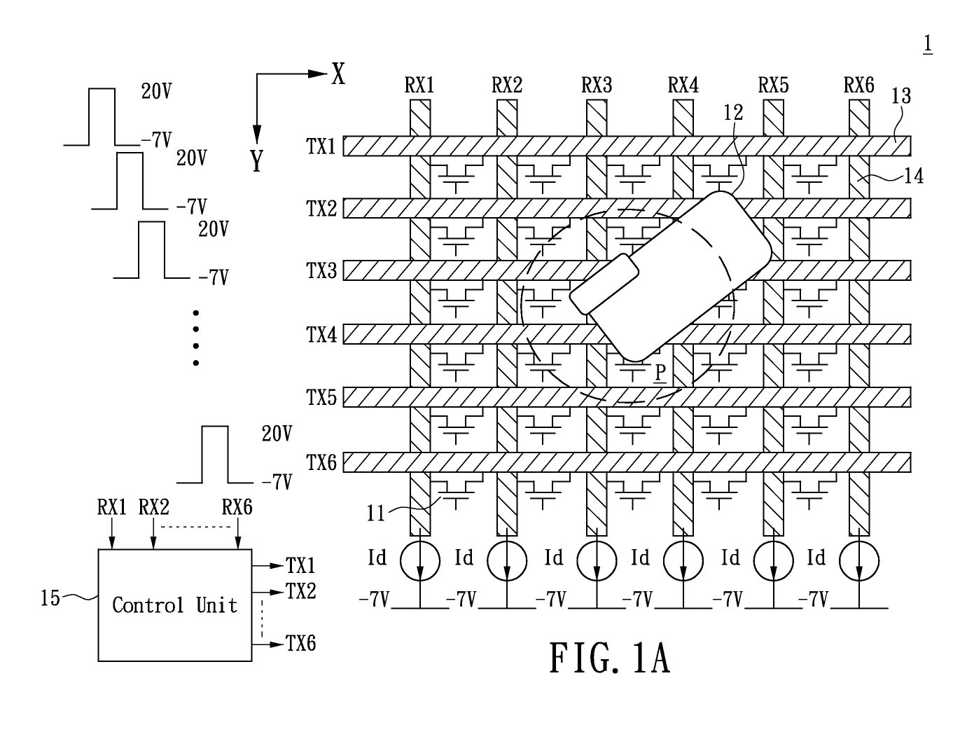

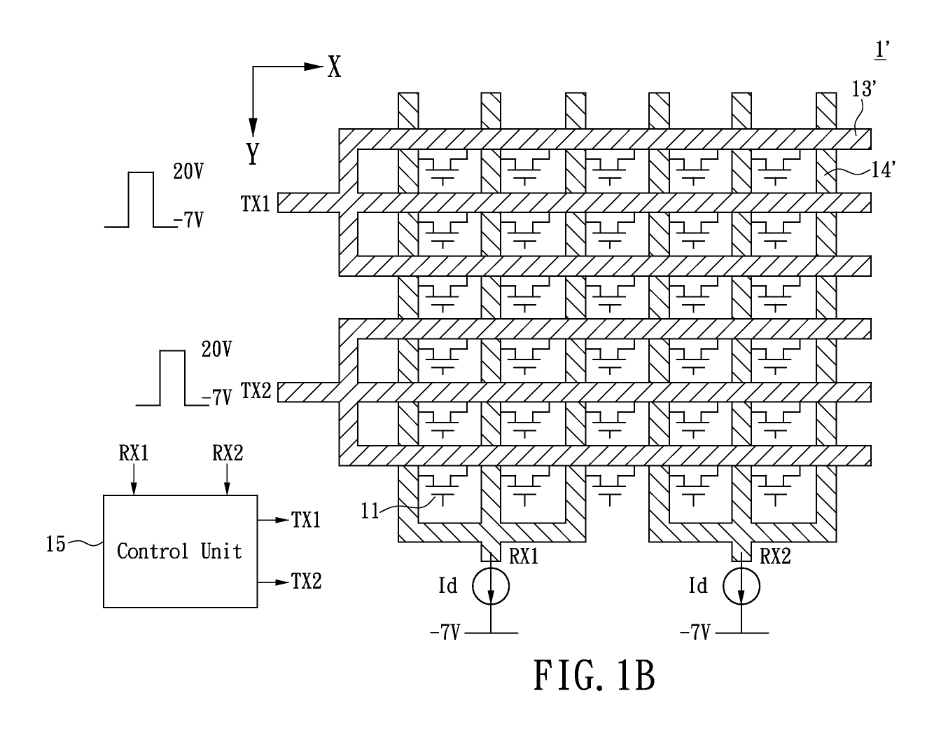

Referring to FIG. 1A, FIG. 1A is a planar view diagram of a touch device according to an exemplary embodiment of the present disclosure. The touch device 1 comprises a substrate (not shown in FIG. 1A, and the substrate can be a insulation substrate, for example), a plurality of floating gate transistors 11, a plurality of touch control driving lines 13, and a plurality of touch control sensing lines 14, wherein the floating gate transistors 11 are arranged in an array, the touch control driving lines 13 are extending along with a row direction (such as X axis) and arranged parallel to each other, and the touch control sensing lines 14 are extending along with a column direction (such as Y axis) and arranged parallel to each other.

The floating gate transistor 11 has a source, a drain, and an active layer located between the source and the drain. The floating gate transistors 11 are formed on the substrate, the drains of the floating gate transistors 11 arranged on a same row are electrically connected to the same touch control driving line 13, and the sources of the floating gate transistors 11 arranged on a same column are electrically connected to the same touch control sensing line 14. Each of the floating gate transistors 11 does not have a gate, and the active layer of each of the floating gate transistors 11 is coupled to the substrate directly or indirectly (such as through the black matrix layer); or alternatively, each of the floating gate transistors 11 has a gate, but the gate is floating.

The touch control driving lines 13 and the touch control sensing lines 14 are electrically connected to the control unit 15, wherein the control unit 15 can be independent to the touch device 1, or integrated into the touch device 1. The control unit 15 can transmit the touch control driving signals TX1˜TX6 to the touch control driving lines 13, and can receive the touch control sensing signals RX1˜RX6 on the touch control sensing lines 14. Compared to that the conventional touch device senses the changes of the mutual capacitance associated with the touch control driving lines and the touch control sensing lines to determine the touch position, the touch device 1 sense the on and off states of the floating gate transistors 11 to determine the touch position.

In exemplary embodiment of FIG. 1A, the control unit 15 sequentially transmits the touch control driving signals TX1˜TX6 to the touch control driving lines 13 by using a time division multiplexing manner. When the voltage of the touch control driving signal TX1 is a high level (such as 20 volts), the control unit 15 can receive the touch control sensing signals RX1˜RX6, and accordingly determine whether the floating gate transistors 11 arranged on the row associated the touch control driving line 13 for receiving the touch control driving signal TX1 are turned on or off. In short, one floating gate transistor 11, one touch control driving line 13, and one touch control sensing line 14 can form a touch cell.

When a charged object (such as a finger 12 or the other touch tool) touch the substrate at the touch position P, the finger 12 or the other touch tool can equivalently serve as the gate of the floating gate transistor 11 at the touch position P if the floating gate transistor 11 does not have the gate, or the static electricity of the finger 12 or the other touch tool applies a turn-on voltage on the gate of the floating gate transistor 11 at the touch position P if the floating gate transistor 11 has the gate being floating, such that the floating gate transistor 11 at the touch position P is turned on. Therefore, when the touch control driving signal TX4 corresponding to the floating gate transistor 11 has a high level, the touch control sensing signal RX3 corresponding to the floating gate transistor 11 also has a high level. In other words, a current Id passes through the floating gate transistor 11 at the touch position P, and thus the control unit 15 can practically sense the currents of the touch control sensing signals RX1˜RX6 to determine whether the floating gate transistors 11 arranged on the row are turned on or off. However, it is noted that, the mentioned sensing and driving manner are not used to limit the present disclosure.

In addition, under the condition that the floating gate transistor 11 is turned off, if the source and the drain of the floating gate transistor 11 have the voltage potential, a leakage current may be induced, thus leading the control unit 15 to determine the touch position mistakenly. Therefore, under the condition that the floating gate transistor 11 is turned off, it is preferred that the source and the drain of the floating gate transistor 11 should be applied with the same voltage level, so as to reduce the generation of the leakage current, and to enhance the touch control precision of the touch device 1.

Referring to FIG. 1B, FIG. 1B is a planar view diagram of a touch device according to another exemplary embodiment of the present disclosure. Compared to the touch device 1 of FIG. 1A, the arbitrary touch control driving lines 13′ (such as the continuous three touch control driving lines 13′) in FIG. 1B are electrically connected to each other, and the arbitrary touch control sensing lines 14′ (such as the continuous three touch control sensing lines 14′) in FIG. 1B are electrically connected to each other. The electrically connected touch control driving lines receive the same touch control driving signal (such as the touch control driving signal TX1), and the electrically connected touch control sensing lines 14′ transmits the same touch control sensing signal (such as the touch control sensing signal RX1).

Since the present required touch control resolution is not high, the touch device 1′ not only meets the present touch control resolution demand, but also decreases the pin number of the control unit 15. In addition, since some touch control sensing lines 14′ are electrically connected to each other, and some touch control driving lines 13′ are electrically connected to each other, the amounts of the currents Id of the touch control sensing signals RX1 and RX2 which are detected by the control unit 15 are guaranteed to be not small, and the touch control precision of the touch device 1′ in FIG. 1B is enhanced.

It is noted that, the touch device 1 in FIG. 1A or the touch device 1′ in FIG. 1B can be externally set on the liquid crystal panel to form the out-cell touch display, or alternatively, the touch device 1 in FIG. 1A or the touch device 1′ in FIG. 1B can be embedded in the liquid crystal panel to form the in-cell touch display.

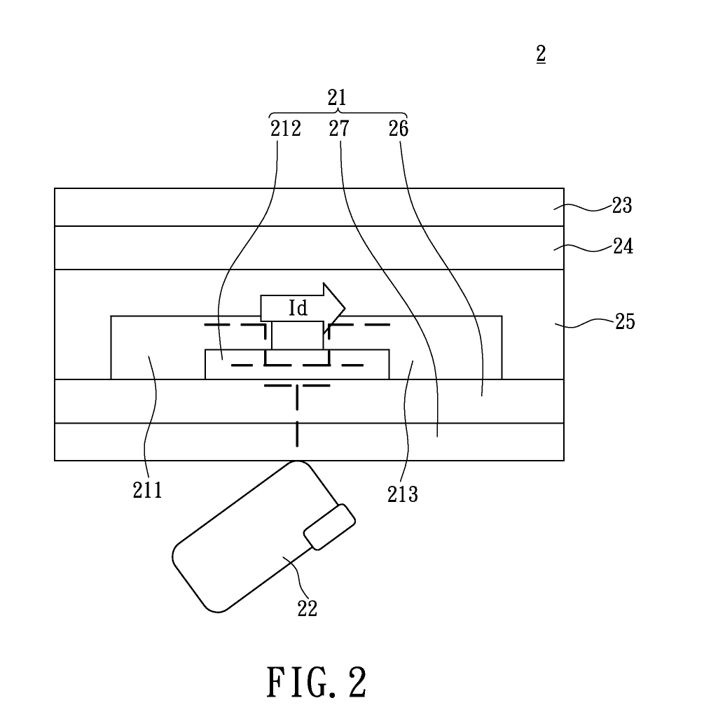

Referring to FIG. 2, FIG. 2 is a section view diagram of a touch display according to an exemplary embodiment of the present disclosure, wherein the touch display 2 in fact is an in-cell touch display. For the object of the convenient explanation, FIG. 2 merely shows a section view of a structure associated with one floating gate transistor, and the other portions (such as a common electrode, a pixel electrode, and a TFT) are omitted. However, it is noted that FIG. 2 is not intended to limit the present disclosure.

The touch display 2 comprises a first substrate (such as a transparent insulation substrate), a touch control and TFT circuit layer 25 and a second substrate (such as a transparent insulation substrate). The touch control and TFT circuit layer 25 is formed on the first substrate, and the second substrate is formed on the touch control and TFT circuit layer 25.

The touch display 2 can be a liquid crystal display, and thus can further comprise a liquid crystal layer set between the substrate and the touch control and TFT circuit layer 25. When using the touch display 2, the touch display 2 should be put upside down, i.e. the first substrate should face the user, and the second substrate is used to receive the light from the back-light source.

The first substrate can be the glass layer 27 or the other transparent substrate, and have a black matrix layer 26 located on the glass layer 27. The second substrate can be the glass layer 23 or the other transparent substrate, and have a black matrix layer 24 located below the glass layer 23. The glass layer 23 may be a glass layer with color filter, and the glass layers 23 and 27 can be replaced by the other transparent substrates, such as the polyethylene terephthalate (PET) substrates. The black matrix layers 24 and 26 are used to prevent the light reflection of inner metal of the touch display 2, and the black matrix layer 24 can further provides an enhancing electrical isolation, so as to enhance the touch control precision. Regardless of the display performance and the touch control precision, at least one of the black matrix layers 24 and 26 can be removed.

The touch control and TFT circuit layer 25 comprises multiple gate lines, multiple data lines, multiple TFTs and multiple floating gate transistors 21. The TFTs are formed on the first substrate and arranged in an array, wherein the TFTs, the gate lines, and the data lines form a plurality of pixel units. Each of the TFTs is electrically connected the corresponding gate line and the corresponding data line, and each of the floating gate transistors 21 is set corresponding to at least one pixel unit. In other words, the touch display 2 comprises multiple pixel units and a first substrate. The pixel units is formed on the first substrate and arranged in the array, and at least one pixel unit comprises a gate line, a data line, a TFT, and a floating gate transistor 21. The TFT is electrically connected to the gate line and the data line.

The floating gate transistor 21 comprises an active layer 212, a drain 211, and a source 212, wherein the drain 211 and the source 213 are respectively located at the two ends of the active layer 212, the active layer 212 is located on the black matrix layer 26, and a first touch electrode line (not shown in FIG. 2) and a second touch electrode line (not shown in FIG. 2) are respectively electrically connected to the drain 211 and the source 213 at the two ends of the active layer 212. To put it concretely, the active layer 212, the drain 211 and the source 213 in the exemplary embodiment form the floating gate transistor 21. The finger 22 or the other touch tool generally has static electric charges, thus when the finger 22 or the other touch tool touches the glass layer 27, finger 22 or the other touch tool is equivalently a virtual gate with charges, and the drain 211, the source 213, and the active layer 212 form a channel, such that the floating gate transistor 21 is turned on, and a conduction path is formed between the drain 211 and source 213. In the exemplary embodiment, the first touch electrode line can be the touch control sensing line, and the second touch electrode lines can be the touch control driving line; or alternatively, the first touch electrode line can be the touch control driving line, and the second touch electrode lines can be the touch control sensing line.

In addition, in another exemplary embodiment, the first touch electrode line can be removed, and the drain 211 of the floating gate transistors 21 can be electrically connected to the gate line; or alternatively, the second touch electrode line can be removed, and the source 213 of the floating gate transistor 21 is electrically connected to the data line. When the source 213 of the floating gate transistor 21 is electrically connected to the data line, the control unit 15 uses the time division multiplexing manner to control the data line to transmit the data signal in the display mode, and to receive the touch control sensing signal in the touch control mode. Even, the first touch electrode line and the second touch electrode line can be removed meanwhile, and the drain and the source of the floating gate transistor 21 are respectively electrically connected to the gate line and the data line. Meanwhile, the control unit can use a time division multiplexing manner to control the data line and the gate line to respectively transmit the data signal and receive the display driving signal in the display mode, and to receive the ouch control sensing signal and transmit the touch control driving signal in the touch control mode.

It is noted that, though the description is under that the case the floating gate transistor 21 in FIG. 2 does not has the gate, but the present disclosure is not limited thereto. As the mentioned above, the floating gate transistor 21 can have a gate being floating in the other exemplary embodiment.

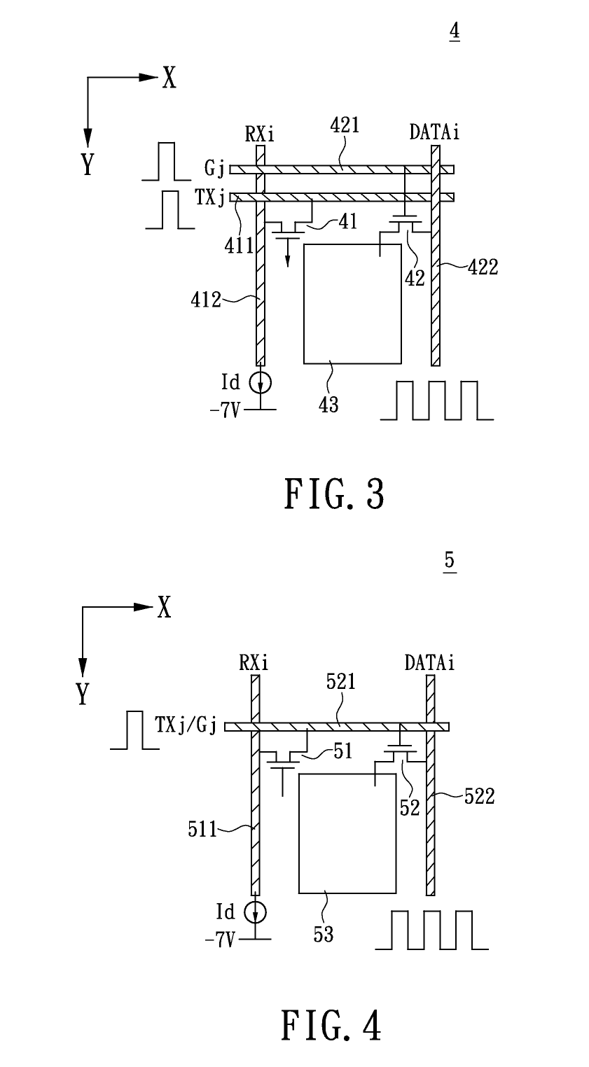

Referring to FIG. 3, FIG. 3 is a planar view diagram of a touch display according to an exemplary embodiment of the present disclosure, wherein the touch display 4 in fact is an in-cell touch display. For the object of the convenient explanation, FIG. 3 merely shows a section view of a structure associated with one pixel unit. However, it is noted that FIG. 3 is not intended to limit the present disclosure.

The touch display 4 has multiple floating gate transistors 41, multiple first touch electrode lines 411, multiple second touch electrode lines 412, multiple gate lines 421, multiple data lines 422, multiple TFTs 42, and multiple pixel electrodes 43. The first touch electrode lines 411 and the gate lines 421 are extending along with the row direction and arranged parallel to each other, and the second touch electrode lines 412 and the data lines 422 are extending along with the column direction and arranged parallel to each other.

The data lines 422 and the gate lines 421 are intersected in the planar view to define multiple pixel regions, and the TFTs 42 are respectively located in the pixel regions, i.e. the data lines 422, the gate lines 421, and the TFTs 42 form multiple pixel units. Each of the pixel electrodes 43 is set corresponding to one of the TFTs 42. In FIG. 3, each of the floating gate transistors 41 is set corresponding to each of the TFTs 42, and as mentioned above, the present disclosure is not limited thereto. In another exemplary embodiment, each of the floating gate transistors 41 is set corresponding to one of several TFTs 42 among all TFTs 42 (i.e. each several TFTs 42 has one floating gate transistors 41).

The pixel electrodes 43 are electrically connected to the source of the TFTs 42, the gates of the TFTs 42 on the same row are electrically connected the same gate line 421, and the drains of the TFTs 42 on the same column are electrically connected the same data line 422. The gate line 421 receives the display driving signal Gj, and the data line 422 the data signal DATAi writing to the pixel electrode 43. The source and the drain of the floating gate transistor 41 are respectively electrically connected to the second touch electrode line 412 and the first touch electrode line 411, wherein the first touch electrode line 411 serves as the touch control sensing line for transmitting the touch control driving signal TXj, and the second touch electrode line 412 serve as the touch control sensing line for receiving the touch control sensing signal RXi.

It is noted that, in the exemplary embodiment, touch control sensing and displaying can be performed meanwhile, and the time division multiplexing manner is not needed. In another exemplary embodiment, the touch control driving signal TXj can be selectively replaced by the display driving signal Gj. Though the aperture ratio of the structure of the touch display 4 is decreased due to the additional first touch electrode line 411 and the second touch electrode line 412, the touch display 4 has the more free dimension to design the touch control driving signal TXj and the touch control sensing signal RXi because the floating gate transistor 41 and the TFT 42 do not share the data line 422 and the gate line 421.

Referring to FIG. 4, FIG. 4 is a planar view diagram of a touch display according to another exemplary embodiment of the present disclosure, wherein the touch display 5 is in fact is an in-cell touch display. For the object of the convenient explanation, FIG. 4 merely shows a section view of a structure associated with one pixel unit. However, it is noted that FIG. 4 is not intended to limit the present disclosure.

The touch display 5 has multiple floating gate transistors 51, multiple first touch electrode lines 511, multiple gate lines 521, multiple data lines 522, multiple TFTs 52, and multiple pixel electrodes 53. The gate lines 521 are extending along with the row direction and arranged parallel to each other, and the first touch electrode lines 511 and the data lines 522 are extending along with the column direction and arranged parallel to each other.

Being different from the touch display 4 in FIG. 3, the source and the drain of the floating gate transistor 51 in FIG. 4 are respectively electrically connected to the first touch electrode line 511 and the gate line 521, wherein the first touch electrode line 511 serves as the touch control sensing line for receiving the touch control sensing signal RXi.

It is noted that, in the exemplary embodiment, touch control sensing and displaying can be performed meanwhile, and the time division multiplexing manner is not needed. In another exemplary embodiment, the touch control driving signal TXj can be selectively replaced by the display driving signal Gj. The aperture ration of the structure of the touch display 5 is enhanced since the gate line 511 is shared by the floating gate transistor 51 and the TFT 52.

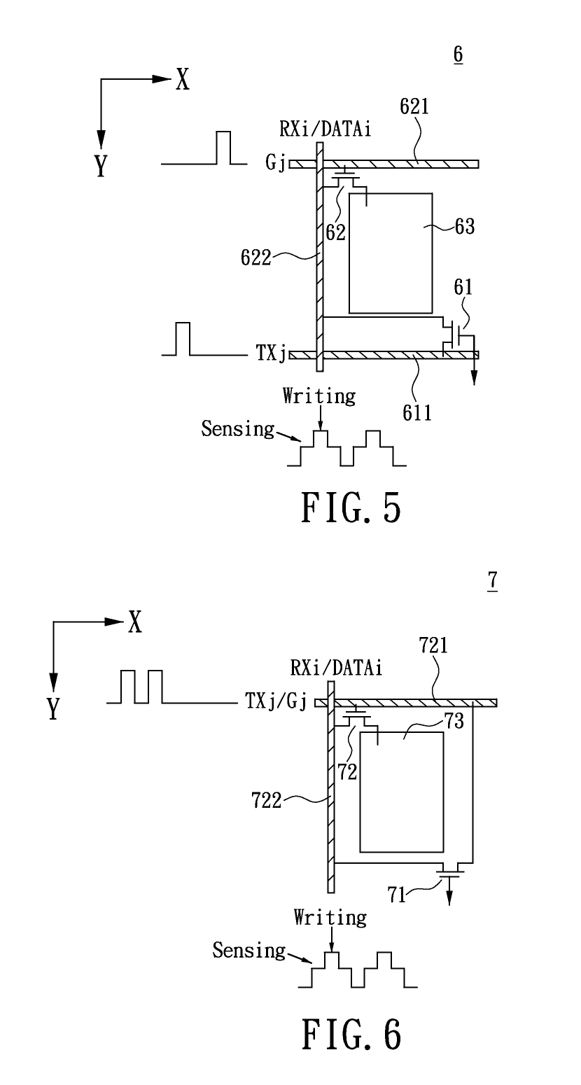

Referring to FIG. 5, FIG. 5 is a planar view diagram of a touch display according to another exemplary embodiment of the present disclosure, wherein the touch display 6 is in fact is an in-cell touch display. For the object of the convenient explanation, FIG. 5 merely shows a section view of a structure associated with one pixel unit. However, it is noted that FIG. 5 is not intended to limit the present disclosure.

The touch display 6 has multiple floating gate transistors 61, multiple first touch electrode lines 611, multiple gate lines 621, multiple data lines 622, multiple TFTs 62, and multiple pixel electrodes 63. The first touch electrode lines 611 and the gate lines 621 are extending along with the row direction and arranged parallel to each other, and the data lines 622 are extending along with the column direction and arranged parallel to each other.

Being different from the touch display 4 in FIG. 3, the drain and the source of the floating gate transistor 61 in FIG. 5 are respectively electrically connected to the first touch electrode line 611 and the data line 622, wherein the first touch electrode line 611 serves as the touch control driving line for transmitting the touch control driving signal TXj. It is noted that, in the exemplary embodiment touch control sensing and displaying cannot be performed at the same time, i.e. the time division multiplexing manner is needed.

In the exemplary embodiment, the control unit controls the data line 622 to operate in the display mode and the touch control mode by using the time division multiplexing manner. Since the data line 622 is shared by the floating gate transistor 61 and the TFT 62, the turn-on time of the TFT 62 is sacrificed. Thus, before the TFT 62 is turned on, the touch control driving signal TXj should be transmitted to the floating gate transistor 61, and the data signal DATAi is allowed to be written to the pixel electrode 63 merely after the touch control sensing is finished.

Thus, the display driving signal Gj changes from the low level to the high level to turn on the TFT 62 after the touch control driving signal TXj changes from the high level to the low level. When the display driving signal Gj is the high level, the control unit controls the data line 622 operate in the display mode to transmit the data signal DATAi; and when the touch control driving signal TXj is the high level, the control unit control the data line 622 to operate in the touch control sensing mode to receive the touch control sensing signal RXi. In the similar manner, the data lines 622 is shared by the floating gate transistors 61 and the TFT 62, and thus the touch display 6 has the enhanced aperture ration.

Referring to FIG. 6, FIG. 6 is a planar view diagram of a touch display according to another exemplary embodiment of the present disclosure, wherein the touch display 7 is in fact is an in-cell touch display. For the object of the convenient explanation, FIG. 6 merely shows a section view of a structure associated with one pixel unit. However, it is noted that FIG. 6 is not intended to limit the present disclosure.

The touch display 7 has multiple floating gate transistors 71, multiple gate lines 721, multiple data lines 722, multiple TFTs 72, and multiple pixel electrodes 73. The gate lines 721 are extending along with the row direction and arranged parallel to each other, and the data lines 722 are extending along with the column direction and arranged parallel to each other.

Being different from the touch display 4 in FIG. 3, the drain and the source of the floating gate transistor 71 in FIG. 6 are respectively electrically connected to the data line 722 and the gate line 721. It is noted that, in the exemplary embodiment touch control sensing and displaying cannot be performed at the same time, i.e. the time division multiplexing manner is needed.

In the exemplary embodiment, the control unit controls the gate line 721 and the data line 722 to operate in the display mode and the touch control mode by using the time division multiplexing manner. Since the data line 722 is shared by the floating gate transistor 721 and the TFT 722, the turn-on time of the TFT 72 is sacrificed. Thus, before the TFT 72 is turned on, the touch control driving signal TXj should be transmitted to the floating gate transistor 721, and the data signal DATAi is allowed to be written to the pixel electrode 73 merely after the touch control sensing is finished.

Thus, the display driving signal Gj changes from the low level to the high level to turn on the TFT 72 after the touch control driving signal TXj changes from the high level to the low level. Thus, in FIG. 6, there are two continuous pulses in the signal of the gate line 721, where the first pulse serves as the touch control driving signal TXj, and the second pulse serves as the display driving signal Gj. When the display driving signal Gj is the high level, the control unit controls the data line 722 to operate in the display mode to transmit the data signal DATAi; and when the touch control driving signal TXj is the high level, the control unit controls the data line data line 722 to operate in the touch control mode to receive the touch control sensing signal RXi. Since the gate line 721 and the data line 722 are shared by the floating gate transistor 71 and the TFT 72, the touch display 7 has a successfully enhanced aperture ration.

It is noted that, each of the mentioned touch displays or touch devices can be installed in an electronic apparatus, and the touch display or the touch device is electrically connected to the electronic apparatus body. The electronic apparatus is for example a smart phone, an automated teller machine, a pad, or a portable game device.

In summary, the touch device provided by the exemplary embodiment of the present disclosure comprises multiple floating gate transistors arranged in an array fashion, and a control unit can sense the on/off states of the floating gate transistors to determine a touch position. Compared to the conventional mutual capacitive touch device, the touch device has a high touch control sensing precision. Furthermore, the touch device can be easily embedded in the liquid crystal panel to form a touch display, and the electronic apparatus using the touch display has a small thickness, thus meeting the small, thin, short, and light trend of the electronic apparatus.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A touch device, comprising:
a substrate;
a plurality of floating gate transistors, formed on the substrate, wherein each of the floating gate transistors comprises a first electrode, a second electrode, and an active layer located between the first electrode and the second electrode;
a plurality of first touch electrode lines, extending along with a row direction and arranged parallel to each other and; and
a plurality of second touch electrode lines, extending along with a column direction and arranged parallel to each other and;
wherein the first electrodes of the floating gate transistors arranged on a same row are electrically connected to the same first touch electrode line, and the second electrodes of the floating gate transistors arranged on a same column are electrically connected to the same second touch electrode line; when a charged object approaches to the floating gate transistor, the first electrode, the second electrode, and the active layer form a channel to make the first touch electrode line and second touch electrode line conductive to each other.

2. The touch device according to claim 1, wherein the floating gate transistor further comprises a gate, and the gate is floating.

3. The touch device according to claim 1, wherein the first electrode and the second electrode of the floating gate transistor are applied with a same voltage.

4. A touch display, comprising:
a first substrate; and
a plurality of pixel units, formed on the first substrate, wherein at least the pixel unit comprises:
a gate line, extending along with a row direction;
a data line, extending along with a column direction;
a thin-film transistor, electrically connected to the gate line and the data line; and
a floating gate transistor, comprising:
a first electrode;
a second electrode; and
an active layer, located between the first electrode and the second electrode;
wherein when a charged object approaches to the floating gate transistor, the first electrode, the second electrode, and the active layer form a channel.

5. The touch display according to claim 4, wherein the floating gate transistor further comprises a gate, and the gate is floating.

6. The touch display according to claim 4, wherein the first electrode and the second electrode of the floating gate transistor are applied with a same voltage.

7. The touch display according to claim 4, wherein the first electrode is electrically connected the gate line, and the second electrode is electrically connected to the data line.

8. The touch display according to claim 4, wherein at least the pixel unit further comprises:
a touch control electrode line, extending along with the column direction and being parallel to the gate line, or alternatively, extending along with the row direction and being parallel to the data line, wherein the first electrode is electrically connected to the touch control electrode line, and the second electrode is electrically connected to the data line or the gate line.

9. The touch display according to claim 4, wherein at least the pixel unit further comprises:
a first touch electrode line, extending along with the row direction and being parallel to the gate line; and
a second touch electrode line, extending along with the column direction and being parallel to the data line,
wherein the first electrode is electrically connected to the first touch electrode line, and the second electrode is electrically connected to the second touch electrode lines.

10. The touch display according to claim 4, further comprising:
a liquid crystal layer, form on the pixel units;
a second substrate, formed on the liquid crystal layer; and
a back-light source, formed on the second substrate.

11. An electronic apparatus, comprising:
an electronic apparatus body; and
a touch display, electrically connected to the electronic apparatus body, comprising:
a first substrate; and
a plurality of pixel units, formed on the first substrate, wherein at least the pixel unit comprises:
a gate line, extending along with a row direction;
a data line, extending along with a column direction;
a thin-film transistor, electrically connected to the gate line and the data line; and
a floating gate transistor, comprising:
a first electrode;
a second electrode; and
an active layer, located between the first electrode and the second electrode;
wherein when a charged object approaches to the floating gate transistor, the first electrode, the second electrode, and the active layer form a channel.

12. The electronic apparatus according to claim 11, wherein the floating gate transistor further comprises a gate, and the gate is floating.

13. The electronic apparatus according to claim 11, wherein the first electrode and the second electrode of the floating gate transistor are applied with a same voltage.

14. The electronic apparatus according to claim 11, wherein the first electrode is electrically connected the gate line, and the second electrode is electrically connected to the data line.

15. The electronic apparatus according to claim 11, wherein at least the pixel unit further comprises:
a touch control electrode line, extending along with the column direction and being parallel to the gate line, or alternatively, extending along with the row direction and being parallel to the data line, wherein the first electrode is electrically connected to the touch control electrode line, and the second electrode is electrically connected to the data line or the gate line.

16. The electronic apparatus according to claim 11, wherein at least the pixel unit further comprises:
a first touch electrode line, extending along with the row direction and being parallel to the gate line; and
a second touch electrode line, extending along with the column direction and being parallel to the data line,
wherein the first electrode is electrically connected to the first touch electrode line, and the second electrode is electrically connected to the second touch electrode lines.

17. The electronic apparatus according to claim 11, wherein the touch display further comprises:
a liquid crystal layer, form on the pixel units;
a second substrate, formed on the liquid crystal layer; and
a back-light source, formed on the second substrate.
